(19) United States
(12) Patent Application Publication
(10) Pub. No.: US 2003/0076352 A1
(43) Pub. Date: Apr. 24, 2003

(54) Note taking, organizing, and studying software

(76) Inventors: Ronald P. Uhlig, Carlsbad, CA (US); Joshua Uhlig, Carlsbad, CA (US); Shawn Joyce, Carlsbad, CA (US); Rodney Guenther, Carlsbad, CA (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/273,054

(22) Filed: Oct. 17, 2002

Related U.S. Application Data
(60) Provisional application No. 60/343,947, filed on Oct. 22, 2001.

(51) Int. Cl. G09G 5/00

(52) U.S. Cl. 345/738

(57) ABSTRACT

A note taking program is provided which allows a user to take notes on an electronic note card from content being read. The note card includes a list of keywords, a list of links to related material, and a field of associated material in addition to a note text field. The note cards are contained in groups, and each group of note cards can contain note card stacks. The program allows for searching of the note cards and displaying of the note cards in various different formats to facilitate review and organization of the note cards. Additionally, note cards can be enabled to be viewed as flashcards.

### CROSS-REFERENCE TO RELATED APPLICATIONS

This application claims priority to provisional application Ser. No. 60/343,947 filed Oct. 22, 2001, which is entitled “Note Taking, Organizing, And Studying Software” and which is incorporated herein by reference.

### STATEMENT REGARDING FEDERALLY SPONSORED RESEARCH OR DEVELOPMENT

Not Applicable.

### BACKGROUND OF THE INVENTION

This invention relates to educational or study software, and, in particular, to software which allows a reader to take electronic notes while reading an electronic book, organizing the notes for further uses, such as writing papers, reports, etc, and for studying the notes.

Electronic books (or e-books) and readers (or e-readers) for e-books are becoming more and more popular. To date, due to the limitations of the electronic readers, their use has been limited for use in pleasure reading—i.e., reading novels. E-readers typically have a small screen and a short battery life. These limitations have limited the use of e-readers; and to date, e-readers are not widely used for educational purposes. Reading software has also been developed for use with laptop and desktop computers. Such software includes Microsoft Readerm, available from Microsoft Corp., Palm Reader™ available from Palm, Inc. of Santa Clara, Calif., and Adobe Acrobat® Reader available from Adobe Systems Inc. of San Jose, Calif. However, laptop and desktop computers are expensive, and, at least in the case of desktop computers, are not easily transported.

Again, as noted, due to screen size limitations of hand held units, and portability and size limitations associated with desktop and laptop computers, electronic reading software has not made a significant impact in the educational market. However, new technology is currently under development to provide reading units, in the form of tablet computers, which have larger screens, and therefore, will find a greater acceptance in the educational market for educational purposes.

### BRIEF SUMMARY OF THE INVENTION

Briefly stated, a computer program of the present invention resides in a computer, such as a hand held, lap top, or desk top computer and enables a user to take notes in note cards on the text being read, and to sort and study the note cards. The computer includes a display, an input device, a pointing device and a storage device. The program allows a user to generate groups of note cards. The notes cards of the note card groups can be organized into note card stacks (or sub-groups). The notes cards can also be organized into a matrix format. Desired note cards can also be activated for use as flashcards.

When generating note cards, the program displays a blank note card screen. The note card screen includes a note title field, a note text field, a link field, an associated material field, and a key word field. Additionally, the note card screen is accompanied by a note list table which displays the title of previously created notes, the title of the currently open note card group, and the titles of any currently opened context sources (i.e., e-books). To make a note card, the user inputs desired note information in the note text field. Links to other files (such as internet sites, computer files, pages of other e-books, etc.) can be entered in the link field. Keywords are entered in the key word field by entering a keyword-identification mode and clicking on desired words in the note card fields. Associated material (such as all or a portion of an electronic book, all or a portion of a computer file, or all or a portion of a web page, sound data, or picture data) can be entered in the associated material field. The user need not enter information in all the fields. That is, the user need not enter keywords, links, or associated material. The user can selectively display any or all of the note fields. To easily identify the note card, the program automatically uses the first N words (i.e., the first five words) of the note text for the note card title; and the note card title is displayed in a note list table on the note card screen. However, the user can provide his or her own title for the note card by typing a title in the note card title field. Hence, the program automatically names the note card; but the user can supply a user provided name to the note card. Additionally, multiple note cards can be saved together as a note card group. The note card group can be named and saved, and the note card group name will be displayed in the note list table once saved. Further, a group of note cards within a note card group can be associated together to form a subgroup or stack of note cards.

Selected note cards can be tagged as flashcards for review in a flashcard format. A note card is tagged as a flashcard by pressing on a flashcard button on the note card screen. An icon will then appear to indicate that the note card has been activated as a flashcard. The flashcard can be viewed with selected text (i.e., flashwords) blanked out or with all the flashwords shown. To select flashwords, the user activates a flashword-selection mode, and then selects one or more words from the note card as flashwords. These selected words are then tagged as flashwords. The flashwords can be chosen from any field of the note card, but preferably are chosen from the note text and associated text fields. Preferably, the words selected as flashwords are highlighted when the flashcard is viewed in the note card format.

Each field on the note card can have three states when the note card is viewed as a flashcard: visible and expanded (shown); visible and collapsed (iconized); and hidden. When a field is iconized, and if data is contained in the field, then an icon will be displayed for the field on the flashcard. By clicking on the field's icon, the field will then be toggled between being displayed and hidden on the flashcard.

When the flashcards are viewed as flashcards, the flashwords can be selectively blanked. The user can opt to have the missing terms automatically filled in after a predetermined period of time or after a “hint” button is pressed, or the user can fill in the missing terms. The program can optionally advance through a series of flashcards at a predetermined interval or based on user interaction. If the missing terms are to be filled in by the user (i.e., the flash cards are being used in a “quiz” mode), the program can keep track of the number of correct answers; keep track of the incorrectly answered terms; and provide a score to the user. Additionally, the user can opt to be allowed to have a predetermined number of tries to fill in the blank, and, if the blank is not filled in correctly within the allotted number of tries, the program can automatically fill in the correct answer. Optionally, the users can choose not to have the flashwords blanked out. In this case, the blanks will be shown filled in.

Alternatively, the user can tag a note card as a flashcard without selecting any words as flashwords. This will allow the user to select desired note cards for review via the flashcard option. In this instance, because no words have been tagged as flashwords, there will be no words highlighted when the flashcard is viewed; nor will any words be blanked out. However, such flashcards can be scrolled through either manually, or automatically to allow the user to review a desired set of the note cards. Flashcards that do not contain flashwords will not affect the score when the flashcards are viewed in a “quiz” mode (i.e., with the flashwords blanked out).

Another feature of the program is the ability to allow the user to organize the note cards from one or more note card groups in a matrix format. The matrix comprises an X-axis, a Y-axis, and at least one cell. The cell of a matrix contains at least one note card which includes the X-axis search term and the Y-axis search term for the particular row and column of the matrix into which the cell falls. The user enters x X-axis search terms and y Y-axis search terms (the result of x*y being an integer having a value of 1 or more), and the matrix thus have x*y cells. The search terms include words, phrases, and text characteristics (i.e., color, bold, italics, font, etc.). Once the search terms have been entered, the note cards are searched to determine which note cards have both an X-axis search term and a Y-axis search term in the searched text. The note cards having both an X-axis search term and a Y-axis search term in the searched text are identified and it is determined which cell of the matrix in which the note card belongs. It will be appreciated that more than one note card can be placed in a single cell. Each cell which contains a group of more than one note card can be referred to as a subgroup or as a stack of note cards. The resulting matrix is then displayed with note identifying information in each cell having a note card which includes the X-axis search term and Y-axis search term of the cell. If any one cell has more than one note card therein the note cards within the cell define a note card stack, and the number of note cards in the particular note card stack is indicated. In response to a user input request (for example, clicking on a note card stack), all the note cards in the selected note card stack will be displayed in a two-dimensional matrix (an “Index Card View”). Further, by selecting a single note card from the two-dimensional matrix, a particular note can be viewed in note editor view.

If desired, the user can input search terms for only the X-axis or the Y-axis. This would form an array that is a single column or a single row. When the user enters search terms in the X and Y axis, the search terms are “anded” together, and notes that contain only the X-search term and the Y-search term for the particular matrix cell are entered in the cell. However, providing only X or Y search terms, in effect, allows for the user to “or” the various search terms together, to, for example, find the cards that include “search term A” or “search term B”.

Note cards in the Index Card View can be manipulated like index cards laid out on a surface. Multiple note cards can be stacked on top of each other to create a new stack of note cards, and the stacks can be given unique names to identify and differentiate the note card stacks from each other. Similarly, note cards can be removed from a note card stack so that it will no longer be associated with a particular note card stack.

The note cards can also be viewed in an “Outline View”. This view of the note cards displays selected information of the note card in a table format. Individual note cards can be manipulated under the outline view in the same manner as in the Index Card View; i.e., individual notes can be combined to form new note card stacks, can be removed from one note card stack, or can be added to a note card stack.

### BRIEF DESCRIPTION OF THE SEVERAL VIEWS OF THE DRAWINGS

FIG. 1 is a block diagram of a computer unit in which the software of the present invention resides;

FIG. 2 is a schematic view of a note screen of the software program with a full note card in the note screen, the note card being shown in a note editor view to allow for entry and viewing of information in the note card;

FIG. 3 is a view of a note screen in half-screen format so that the source content (i.e., e-book) being read can also be seen;

FIGS. 4 is a schematic of the menu structure of the program of the present invention;

FIG. 5 is a sample “Preferences” dialog box;

FIG. 6 is a state chart showing the use of “Expand” and “Collapse” buttons to switch the program screen between full screen note, full screen content, or split screen note and content;

FIG. 7 shows an example of a “save note group” dialog;

FIG. 8 shows a note card stack with an associated context sensitive popup menu;

FIG. 9 shows a note card group in an outline format;

FIG. 10 shows an “Open Note Group” dialog box;

FIG. 11 is a schematic view of a dialog box for compiling together desired sections of desired material stored in the unit into a single file or user defined ebook;

FIG. 12 is a flow chart for the compiling files and book or book sections into a user defined e-book;

FIG. 13 is a flow chart for the generation of a note matrix group;

FIG. 14 shows an example of a “select note group” dialog box used in creating a note matrix group;

FIG. 15 shows an example of a dialog box for selecting the search terms for the note matrix group;

FIG. 16 shows the “Matrix Preview” tab of the matrix dialog box;

FIG. 17 shows an example of a screen view of a note matrix group;

FIG. 18 shows an example of a note matrix group viewed in an index card view;

FIG. 19 shows an example of a preferences dialog box used to set default preferences for viewing flashcard notes in flashcard format;

FIG. 20 shows an example of a note card with flashwords highlighted;

FIG. 21 shows the note card of FIG. 18 when viewed in flashcard format with the flashwords blanked out;

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes what we presently believe is the best mode of carrying out the invention.

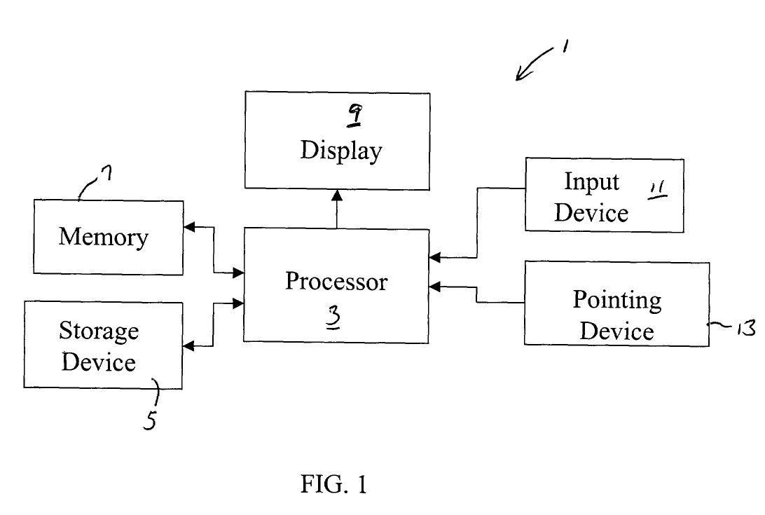

The note taking, organizing, and studying program of the present invention is embodied in machine readable media, such as a hare or removable disk drive, a ROM, an EEPROM, or other type of machine readable media. Additionally, it will be appreciated that the media which contains the program can be either local (i.e., resident in or on the unit in which the program is operated) or it can be remote from the unit which operates the program. In this later instance, the unit would be part of a network, and the program would reside on one of the computers that is part of the network, and is accessible to other computers on the network to be operated by such networked computers. A representative unit 1 on which the software of the present invention can be operated is shown in block form in FIG. 1. The unit 1 is preferably a hand held unit in tablet form, but can be a laptop or desktop computer as well. The unit 1 includes a processor 3; a storage device 5, such as a permanent or removable drive, a flash memory card, RAM, ROM, EPROM, or EEPROM (which is battery powered to prevent loss of information) or other storage devices which may now be known, or might later be developed; a memory 7; a display 9, such as a screen; an input device 11, such as a keyboard or stylus; and a pointing device 13, such as a mouse, trackball or similar device which moves a pointer on the screen. If the program is local to the unit, the program resides on, or is stored on, the storage device 5. The screen 9 can be a touch sensitive screen and can function as the pointing device, or as a pointing device in addition to a mouse or trackball. Further, to the extent the screen is touch sensitive, it can also be used as the input device. In this instance, a stylus would be used to “write” on the screen to enter text into the program. Additionally, to the extent that RAM is used as a storage device, the RAM can function as both the storage device 5 and the memory 7. Further, the unit 1 can include directional keys, which can also be used in conjunction with either the pointing device or the input device.

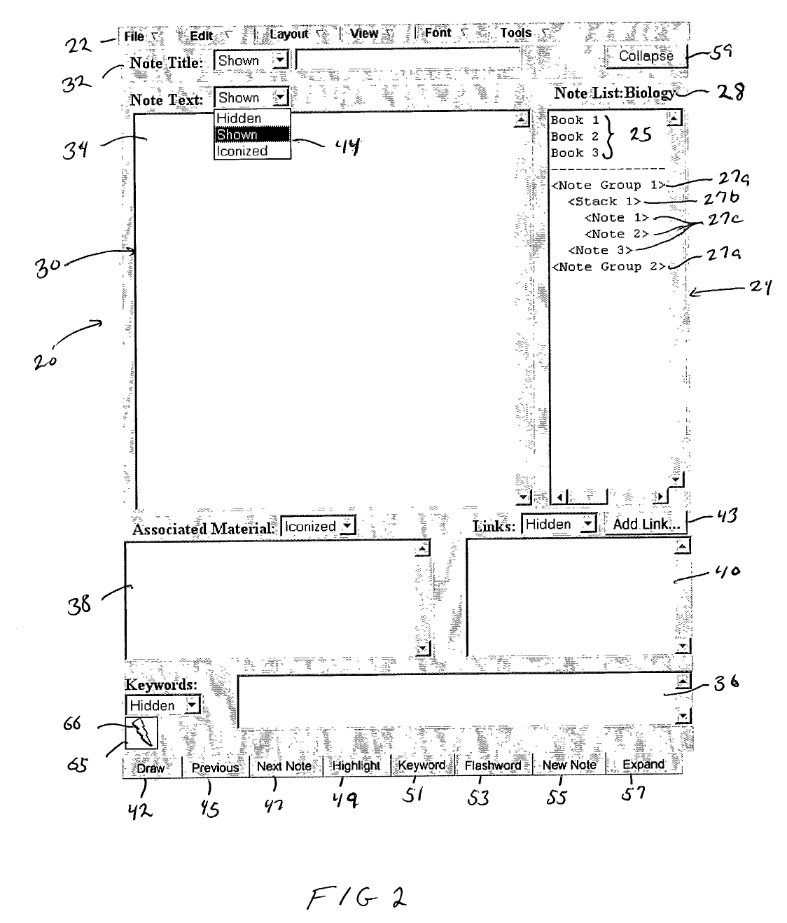

A sample note card screen 20 of the program which resides in the unit 1 is shown in FIG. 2. The note taking program is maintained on the storage device 5 (or on a programmable memory chip) and is uploaded into memory when the program is initiated. As will be discussed below, the program is operable to take and store notes from a content source, such as a text book (either electronic or paper), internet web page, or other file, search the note cards in several different ways to facilitate studying of the note cards, and to format the note cards as flashcards.

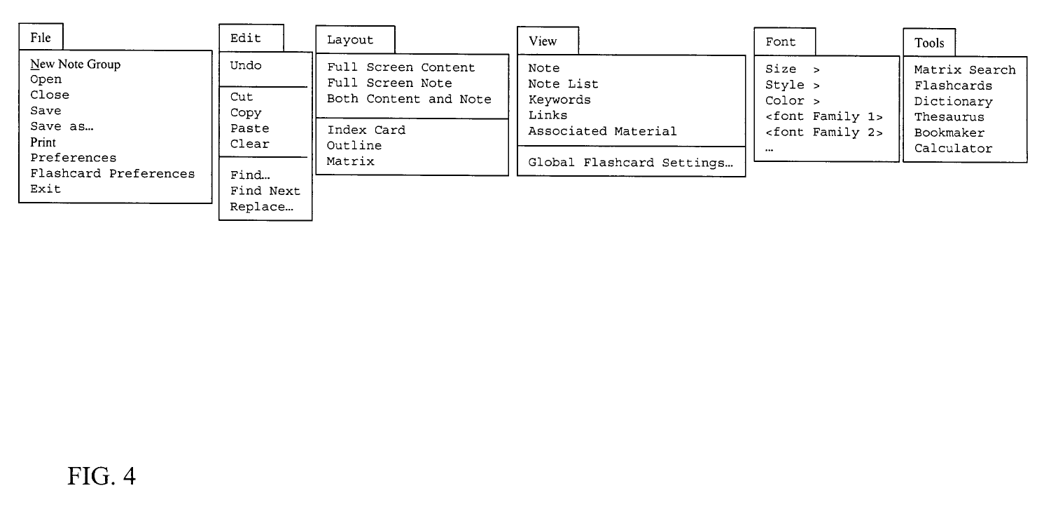

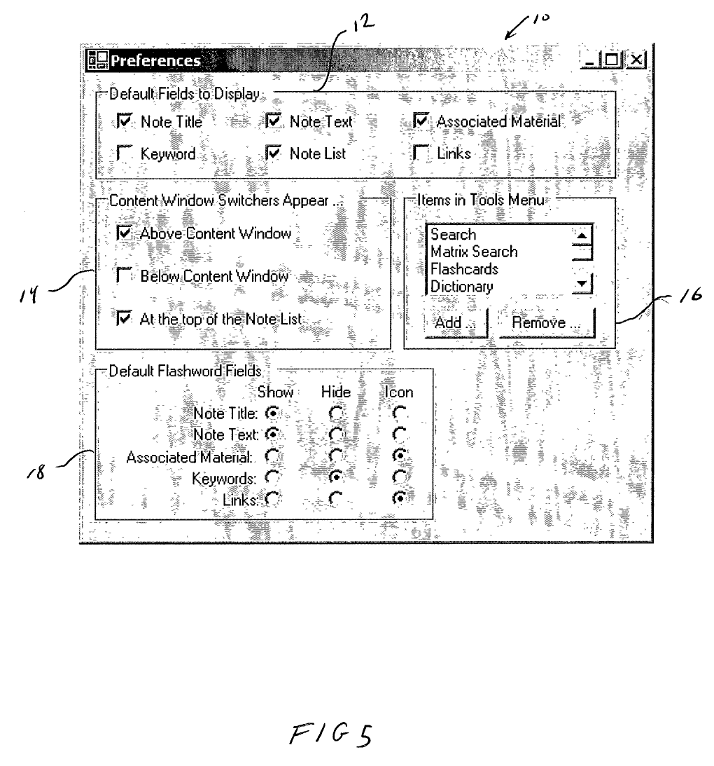

As seen, the note card screen 20 includes a menu bar 22 containing tabs for “file”, “edit”, “layout”, “view”, “font”, and “tools”. The various functions available in the different tabs is shown in FIG. 4, and will be described briefly here. Under “File”, the user can opt to create a new note group, open existing note groups and note matrix groups, close note groups and matrix groups, save note and matrix groups, edit the preferences for the program, edit preferences for flashcard viewing, print notes and note groups, and exit the program. The “open”, “close”, “save”, “print”, and “exit” functions are well known to those skilled in the art, and will not be further described herein. The “Preferences” dialog box 10 which is brought up when the user chooses “preferences” is shown in FIG. 5. As seen, using the “Preferences” dialog box 10, the user can in box 12, select the fields of the note card which will be displayed by default; in box 14, choose where “content window switching” keys appear; in box 16, modify the items available in the “Tools” menu; and, in box 18, select which fields will be shown when the note card is viewed as a flashcard, and the manner in which the field will be shown. Although not shown, the Preferences dialog box 10 could also include a button to activate the flashcard viewer preferences dialog box 251, which is described below.

Under “Edit”, the program provides the user access to undo, cut, copy, paste, clear, find, find next, and replace functions. The use and utility of these functions are well known to those skilled in the art, and will not be further described herein.

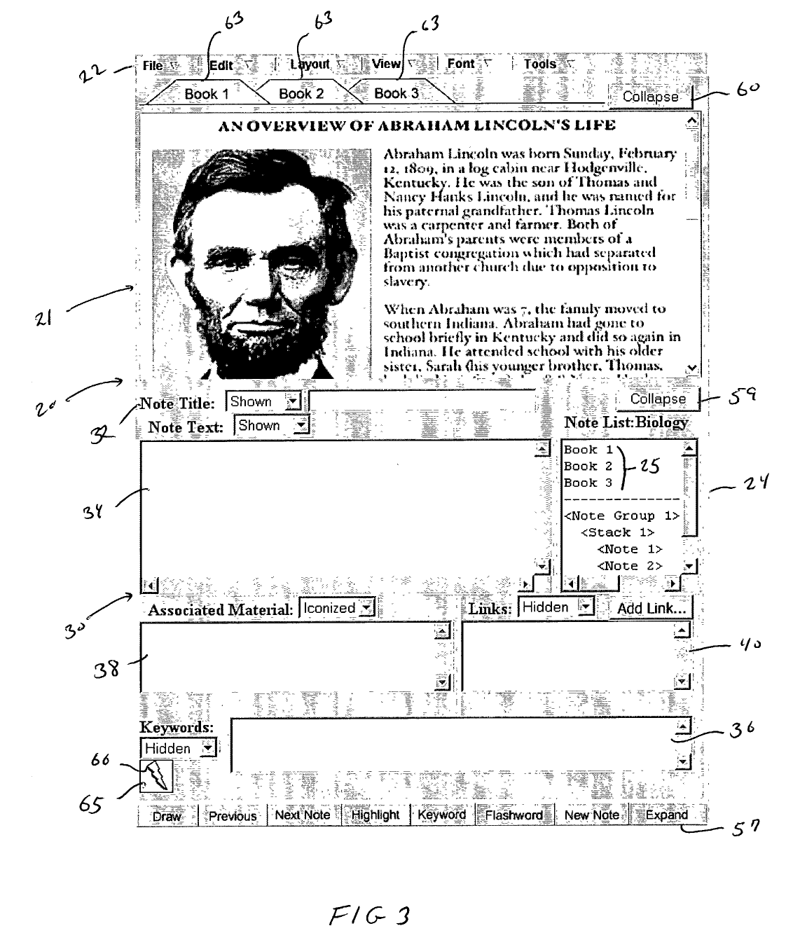

Under the “Layout” tab or option, the user can toggle the screen to show just the note screen 20, just the source content screen 21, or both the note screen 20 and the content screen 21 (FIG. 3). Additionally, the user can opt to view the note cards in “index card” format, “outline” format, or, “matrix” format, as will be described below. Also, as described below, the “matrix” format is a special instance of the “index card” format.

Under “View”, the user can choose which fields of the program screen will be visible when viewing a note. The user can choose any or all of the note text field, note list field, keyword field, links filed, or associated material field. Selection of the fields to view using the “view” menu does not affect the defaults set using the “Preferences” dialog box. Rather, it just affects the fields viewed (or not viewed) for the currently open note group. Additionally, using “Global Flashcard Settings”, the user can activate the flashcard preferences dialog box 251 (described below) to set defaults for viewing flashcards.

Under “Font”, the user can select the characteristics of the font used by the program. For example, the user can select the font family, size, style, color, etc. The user can use the Font styles menu to embolden, italicize, underline, and apply other attributes to the text.

Lastly, under “Tools”, the user can conduct a matrix search of the note cards, review of the notes cards in flashcard format, assemble user-defined “books”, and access and use other applications, such as a calculator, dictionary, thesaurus, spreadsheet program, word processor, and presentation programs. Other applications could also be included (or added to) the “Tools” menu, if desired, as noted above, using the “Preferences” dialog box 10, as discussed above.

Turning back to FIG. 2, the note taking program screen 20 includes a note list or note table 24 which shows the names 25 of the currently opened content sources, the names 27a of the note card groups, the names 27b of note card stacks within the note card groups, and the names 27c of the note cards which make up the note card stacks and the note card group. As described below, individual note cards are stored in note card groups, and hence, the note cards 27c in the note card list 24 are part of a note card group 27c. The note card list is thus headed by a note group title field 28 which shows the name of the currently opened and active note card group. The note screen 20 includes a note card 30. The note card 30 itself, includes a note title field 32, a note text field 34, a keyword field 36, an associated material field 38, and a links field 40. The note text field 34 includes the text of the note (i.e., whatever the user finds important about the passage being read). Although entitled “Note Text”, note text field 34 is not limited to text. It also can contain graphics, sound files, or multimedia files. The note card program screen includes a “draw” button 42, which, when activated, allows for the user to draw figures in the note field 34. The keyword field 36 includes keywords which are used to search the notes when a matrix search is performed, as described below. The “associated material” field 38 is provided to allow the user to input whatever he/she feels might be important to the note. This can include data from the source material read. For example, the passage of the book on which the note comments can be included here. The “associated material” field is identical in function to the “note text” field, and is not limited to textual information. Sound, picture, movie, multi-media or other types of information can be contained in the associated material field as well. Additionally, the “draw” button 42 can be activated to draw images in the associated material field.

The links field 40 includes links to related material. This can be a link to a web site, particular pages of a book, other files (such as text or media files), another note, or another book or section of another book. Links can be entered into the link field 40 simply by “pressing” the “add links” button 43. This will present a dialog box having a text entry box in which, for example, the address of a web page can be entered. Links to other files can be entered by entering the name of the file (including its location in the storage device). The “Add Link” dialog box can include a “browse” button which will bring up a list of files, from which files can be selected. A link to the selected file will then be entered in the link field. In addition to the links entered by the user, a link to the page or section of the text on which the note is taken is automatically entered into the link field. If the note is being taken from a different content source, such as another file or a web page, a link to the file or web page, or other content source is added The link field is not limited to a single link, and the user can insert multiple links into the link field. When the note card is being reviewed, when the link to the content source is clicked or activated, the content source will be opened to the place indicated in the link, so that the user can readily access the source of the note, if desired. Additionally, by clicking on any of the links, the source associated with the link will be opened. Thus, for example, clicking on a link to a web page will activate an internet browser and open the web page. Clicking on a link to a file, will activate the program associated with the file, and open the file.

The user need not enter information in all the fields, rather, the user need only place information in the fields in which (s)he wants to place information. That is, the user need not enter information in the keywords, links, associated material, or even the note text field. For example the user may just want to enter a note in the note text field, and leave the remaining fields blank. Alternatively, the user might want to associate certain material with a page or section of a content source being read, and fill in only the associated material or links fields, while the program creates the link to the section of the content source. These examples are illustrative of the flexibility of the note cards 30.

The “note title”, “note text”, “associated material”, “links” and “keyword” fields each include a drop down list 44 by which the user can select which fields are to be displayed and how they are to be displayed when the note card is viewed as a flashcard. The user is provided with the options of “Shown” (i.e., visible and expanded), “Iconized” (i.e., visible and collapsed), and “Hidden”. In the drawing of FIG. 2, the note title and note text fields are indicated to be shown when the card is viewed as a flash card; the associated material field will be iconized, and the links and keyword fields will be hidden. When “shown” is selected, the field will be shown when the note card is viewed as a flashcard. When “iconized” is selected, the field will be minimized and replaced with an icon (not shown) in flashcard format. When the icon for the particular field is pressed, the field will be enlarged to be shown. When “hidden” is selected, the specific field will not be included on the flashcard. To view a hidden field on the flashcard, the view option would have to be changed using the drop down list 44 for the specific field. The default parameters for the viewing of flash cards are set using the preferences dialog box 10 (FIG. 5). Changes to the view options using the drop down lists 44 will not alter the preferences, but will affect the viewing of all flash cards viewed during the current session. It will be noted that a drop down list 44 is not provided for the note list table 24, and the note list table portion of the note card screen is not included in box 18 of the preferences dialog box 10). This is because it is not anticipated that the note card list 24 would be desirable to be viewed when the note cards are viewed in flashcard format. However, if desired, the user could be presented with the option to make the note card list 24 viewable in the flashcard format.

Below the note card 30, the note screen 20 includes a set of soft keys or buttons. These include the draw button 42, a previous note button 45, a next note button 47, a highlight button 49, a keyword button 51, a flashword button 53, a new note button 55, and an expand button 57. Additionally, a “note collapse” button 59 is provided at the top of the note screen 20. As seen in FIG. 3, a “content collapse” button 60 is provided in the content screen 21.

The “draw” button 42, when activated, provides the user with a “drawing implement” which can be used to draw an image in either the “note” field or the “associated material” field. When the “draw” button 42 is activated, the user is provided with a “pencil” which can be operated with the pointing device to draw a picture in the text or associated material fields. When pressed a second time, the “draw” function is deactivated, and the user is provided with a “text” cursor. Hence, the “draw” button is a software operated toggle switch.

The “previous note” and “next note” buttons 45 and 47 allow the user to scroll through the note cards within a note card group, for example, to review the notes.

The “highlight” button 49, when activated, allows the user to highlight selected text in any of the fields. Preferably, when activated, a pop-up window can be activated which brings up a color palette to allow the user to select a desired color for the text to be highlighted. This will allow the user to color code his or her highlighting. To highlight selected text, the “highlight” button is pressed to activate the highlight function. The user is then presented with a “highlighter cursor” Desired words are selected by, for example, clicking on a word or phrase, or dragging the highlighter cursor across the selected word or phrase. The word or phrase will then be highlighted in the desired fashion. To exit the highlight function, the highlight button is pressed a second time.

The “keyword” button 51 when activated allows the user to select keywords for the note card which will be entered in the note card's “keyword” field 36. To select keywords from the note card, the user “presses” or activates the “keyword” button 55. The user is then presented with a keyword cursor. The user can then select words or phrases from any of the fields, by, for example, clicking on desired words or phrases or dragging the keyword cursor across desired words or phrases. The various selected words and/or phrases are then added to the keyword field after they have been selected (i.e., clicked). The key words, as described below, are used to conduct searches of the note cards using the matrix search function. The keyword selection mode is deactivated by pressing the “keyword” button a second time.

The “flashword” button 53, as will be described below, allows the user to select words and phrases to be hidden when the note cards are previewed in a flashcard format.

The “new note” button 55 opens a blank note card screen 30 for the user to enter a new note.

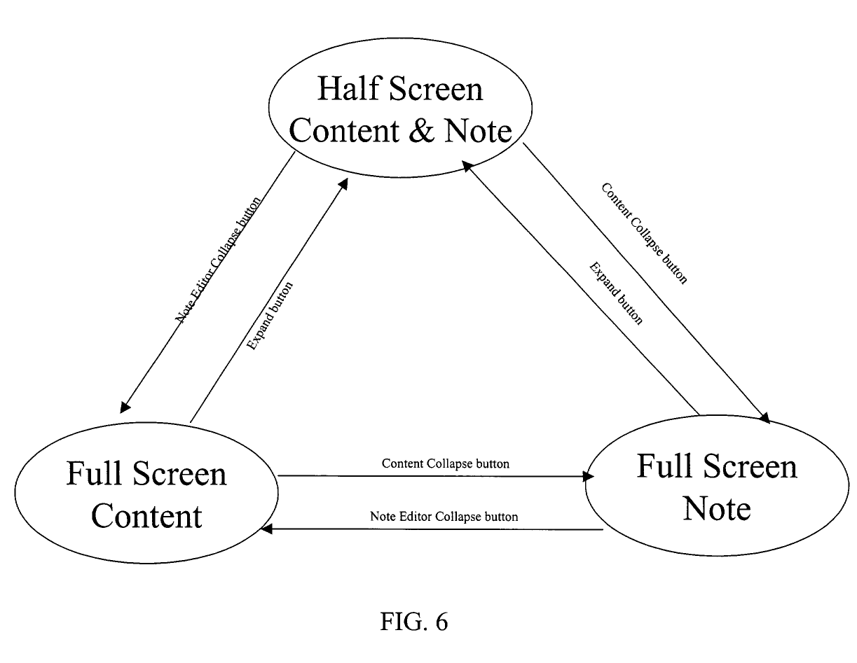

The expand and collapse buttons 57, 59, and 60 are used to shrink or hide the active screen; to expand the active screen to full screen format; or to split the screen between the note screen and the content screen as shown in the state chart of FIG. 6. Turning to FIG. 3, there is a “note collapse” button 59 and a “content collapse” button 60. When the note and content are shown in split screen mode, as seen in FIG. 3, when the “note collapse” button 59 is pressed, the note screen 20 will be hidden, and the content screen 21 will expand to full screen. Conversely, when the “content collapse” button 60 is pressed, the content screen 21 will be hidden, and the note screen 20 will expand to full screen. When the note screen is in full screen mode, as in FIG. 2, when the “note collapse” button 59 is pressed, the note screen 20 will be hidden and the last opened source content screen 21 will be shown in a full screen format. Lastly, when the note card or content are shown in full screen format, when the expand button 57 is pressed, the screen will be switched to a split screen format (as seen in FIG. 3). FIG. 6 is a state diagram showing what occurs when the expand button 57 and collapse buttons 59 ad 60 are activated.

The same action or results can be accomplished via the “layout” menu from the menu bar 22 by selecting “Full Screen Content”, “Full Screen Note” or “Both Content and Note. When “Full Screen Content” is selected, the last viewed or last active content source is shown in full screen. When “Full Screen Note” is selected, the last viewed or last active note group is shown in full screen. And, when “Both Content And Note” is selected, the last active content source and the last active note group are shown in a split screen format. Hence, if a content source is currently displayed in full screen, the content source is reduced to half screen, and the last active note group is displayed in the other half of the screen. Conversely, if a note group is displayed in full screen format, the note group will be reduced to half screen and the last active content source will be displayed in the other half of the screen.

The screen 20 includes a series of “content switching” tabs or buttons 63, shown in FIG. 3 to allow the user to switch between opened content sources (i.e., e-books, web pages, etc.). Preferably, the tabs 63 will display the title of the content source (i.e., book title) associated with the tab. By pressing a desired tab, the user can switch between the opened content sources. The titles 25 of the opened content sources are also shown in the note list 24. The user can also switch between the various opened content sources by clicking on the title 25 of a selected book in the note list 24. Similarly, the user can open a different note group by clicking on the title 27a of a desired note group.

Lastly, the note card includes a flashcard button 65 with an icon 66 (shown as a lighting bolt in this example). As discussed below, a displayed note card is activated (or deactivated) as a flashcard by pressing the flashcard button 65. When activated, the icon 66 will appear. If a note card is not activated as a flashcard, the icon 66 will not be shown in the flashcard button 65. Operation of the flashcard function is explained below.

Turning back to FIG. 4, by selecting the “View” option on the tool bar, the user can select which of the note card fields are to be viewed. At a minimum, the user will see the note title field 32. Additionally, the user can select to view one or more of the note text field 34, the keywords field 36, the associated material field 38, the links field 40, and the note list table 24. By selecting, or deselecting, the fields that are viewed using the “view” menu, the user does not change the default fields viewed which are set in the preferences module. Rather, options made using the “view” menu affect only the note card group currently being viewed and the manner in which other note card groups are opened during the current session. If an additional note card group is opened, then a change in the view options of the displayed (or current) note card group would override the view options of all note groups opened during a particular session. In a latter session (after the program of the current invention has been deactivated and reactivated), however, the note cards would be viewed as set forth in the defaults as set forth in the dialog box 10. Lastly, using the font menu, the font family, font size, font color, and font style (italicized, emboldened, underlined) can be changed.

In basic operation of the note taking portion of the software when the program is started, the program will open a blank note card 30 for a new note group. The note list 24 will contain the new, untitled note group, the new, untitled note card, and the names of any content source that may be opened. The note list title 24 will contain a name, such as “note group 1” or “untitled” for the new note group. Additionally, there will be a title, such as “note 1” or “untitled” for the new note card.

If the user is starting a new note group, then the user simply begins filling in the various fields of the blank note card 30, as discussed above. The note title field 32 is filled in simply by clicking in the note title field 32 and typing in the desired note title. When the note title is entered in the note title field 35, the note title will appear in the note list table 24 at the top of the table. The specific note card can be named at any time during the entry of information in the note card 30. Preferably, the note card will be named prior to creating a new note card. However, if a name is not provided to the note card, the program will automatically give the note card a title from the first, for example, five words of the note text. This assigned name will follow the note card until the user provides a name for the note card.

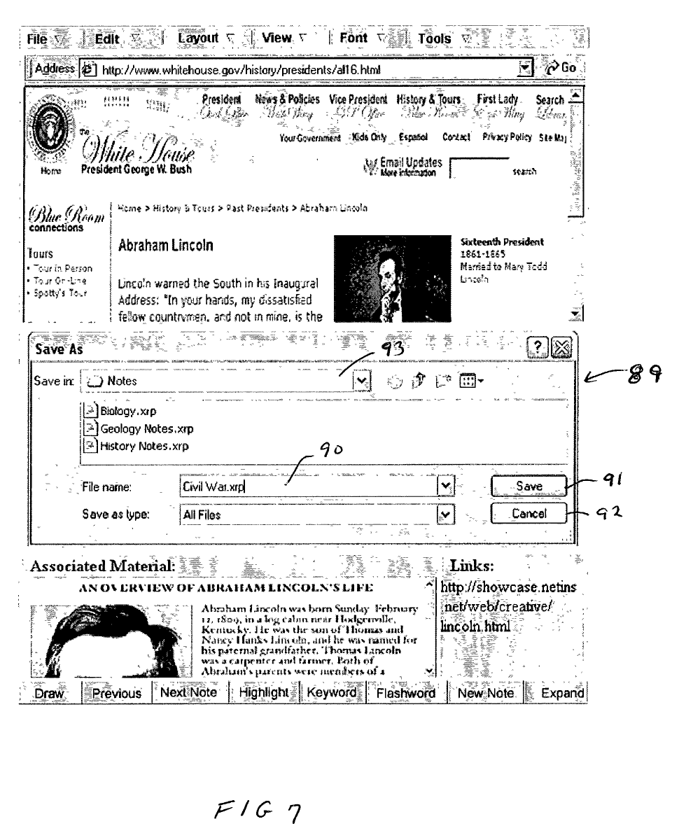

When a new note card group is opened, the note card group name field is blank or is filled entitled “untitled”, “note group 1” or some other similar name, until the note card group is saved. To save the note card group, the user selects “save” or “save as” from the “File” tab of the tool bar 22. The user is then provided with a “save” or “save as” dialog box 89, as seen in FIG. 7. The “Save As” dialog box 89 has a field 90 into which a note card group title can be entered. Using the “save in” box 93, the user can choose the subject folder into which the note card group will be saved. When the “save in” box 93 is activated, the user will be presented with a list of subject folders to choose from. In this manner, the user can segregate various note groups by subject. The dialog box 89 also includes a “save” button 91 and a cancel button 92. After the user enters the note card group name (“Civil War” in the example of FIG. 5) in field 90, and activates the “Save” button 91, the software determines if the note card group name is a new name. If the file name is a new name, the note card group file is saved. If the note card group name is not a new name, the user is presented with a second dialog box which asks the user if the new note card group file should replace the existing note card group. If the user selects “Yes”, the note card group is saved (and the old note card group is overwritten). If the user selects “No”, then the user is returned to the dialog box 89 to enter a different name for the note card group. Once the note card group has been named, the note card group name field 28 is updated to display the name given to the note card group. Additionally, the note card group name 27a in the note list 24 will be updated to display the note card group name. The note card group can be saved at any time prior to, or upon, closing the note card group. The note card group can be saved prior to entering information for the first note card, or at any time while the note card group is opened. If the note card group is closed without saving the note card group, the “save” or “save as” routine will automatically be executed to prompt the user to save the note card group.

The user can also open an existing note card group to enter new note cards in the group (or to perform other operations on the notes, as will be discussed below) by choosing the “Open” function under the “File” tab of the tool bar 22. The manner of operation of “Open” functions is well know to those skilled in the art, and will not be described herein. When an existing note group is opened, the note card group name will appear in the note list table 24 and in the group title field 28. When multiple note card groups are opened, the user can switch between open note card groups by clicking on the note card group name 27a in the note list 24. When this is done, the note card group will be expanded in the note card list 24, for example, as seen in FIG. 2, to display the names of the various note cards which makes up the note card group. Additionally, the note card group title field 28 will be updated to display the title of the new, currently active note card group. When a previously saved note card group is opened, the user can simply review the notes using the previous and next note keys 45 and 47, add new note cards to the group (by pressing the “new note” button 55), and modify existing note cards in the group. If the user adds new note cards to the note card group, or has modified existing note cards in the note card group, the user will be prompted to save the modified note card group upon closing if the modified note card group has not already been saved.

Returning to the task of entering notes, the text of the note is entered simply by entering the note text in the note text field 34, for example, using a keyboard, or by “writing” on a touch sensitive screen. The user can also capture text from an open e-book page, web page, associated material, or other file and place the text in the note field by selecting the text from the source and copying into the note text field. Additionally, by pressing the “draw” button 42, the user will activate a graphics routine or software which will allow the user to make a drawing in the note field 34 or in the associated material field 38. The graphics software preferably will behave similarly to software such as Microsoft Paint, or any similar software which enables a user to make a drawing using a pointing device. When the user is done “drawing” the desired image, the user again “presses” the “draw” button 42. The graphics curser presented by the graphics program will be replaced by a text cursor to allow for entry of information via the keyboard or other input device.

The associated material is placed in the “Associated Material” field 38 by selecting text from a source (such as an e-book), and then copying the text in to the field 38. The associated material can be from the currently selected content source, from the scanned page of a paper book, an internet web page, another file, or from any other source stored in, or available to (i.e., via a network or the internet) the unit 1. The file from which the associated material is taken can be a sound or music file, a multi-media file, a “pdf” file, a picture file (such as a “jpeg”, “bmp”, “tif”, etc. file), an internet (htm or html) file, text file, or any other type of file from which the user may want to associate data with the note. To allow the text of in the “associated material” field 38 to be searchable, the material in the field is preferably in text or PDF-text format. Additionally, as noted above, a drawing can be placed in the associated material field upon activation of the “draw” button 42.

To link files to the note card 30, the address for a desired file is inserted in the “Links” field 40. To link a web page to the note, for example, the user activates the “Add Link” button 43, as noted above and enters the URL for the web page in the text box presented by the add link dialog box. To link to another note, the user selects the note to be linked, and the identifier for the selected note is entered in the link field. To link a file (such as a text, graphic, media file), the user can press a “browse” button (not shown) which is part of the “Add Link” dialog box. The user will be presented with a directory tree of files available on the unit from which the desired file is selected. The desired file is selected, and its address is inserted in the links field. Additionally, as noted above, a link to the page or section of the content source from which the note is taken is automatically entered into the links field. As can be appreciated, the links field does not contain the actual file being linked. Rather, the field contains a pointer, in the form of an address or universal resource locator (URL), and, when the link is clicked or otherwise selected, the linked file will be opened using the appropriate software application (i.e., an internet browser, a word processor, a spreadsheet program, etc.). More than one link can be inserted in the link field 40.

Key words can be entered in the key word field 36 initially by pressing the “key word” soft button 55. The user then selects words or phrases in the note card by highlighting the desired word or phrase, as noted above. The selected word or phrase is then entered in the keyword field.

As noted above, the manner in which the notes are viewed can be changed, using the functions under the “Layout” tab in the tool bar 22. In FIG. 2, the note is shown full screen. As discussed above, the note and content source can be shown in full screen format or split screen format using the “Expand” and “Collapse” buttons and the full screen and split screen options in the Layout menu.

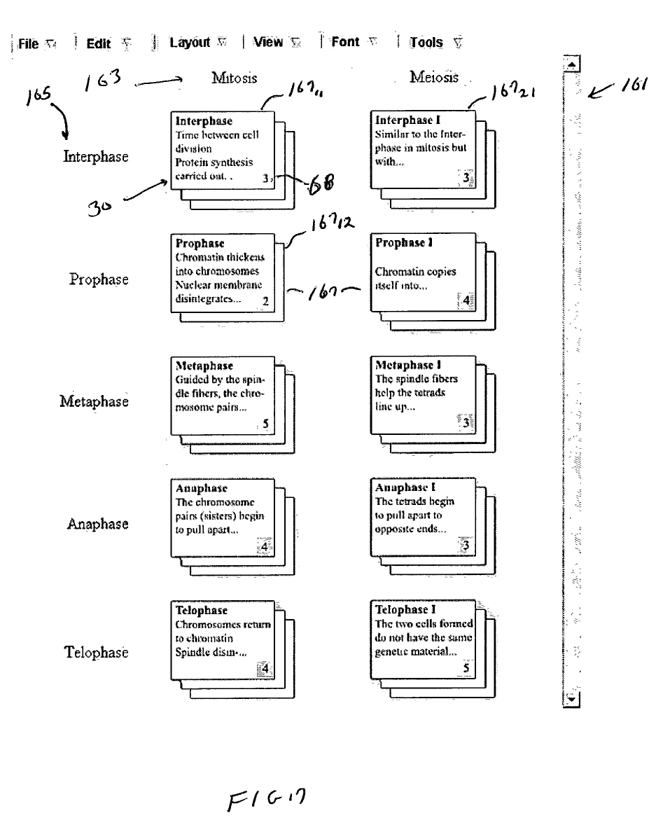

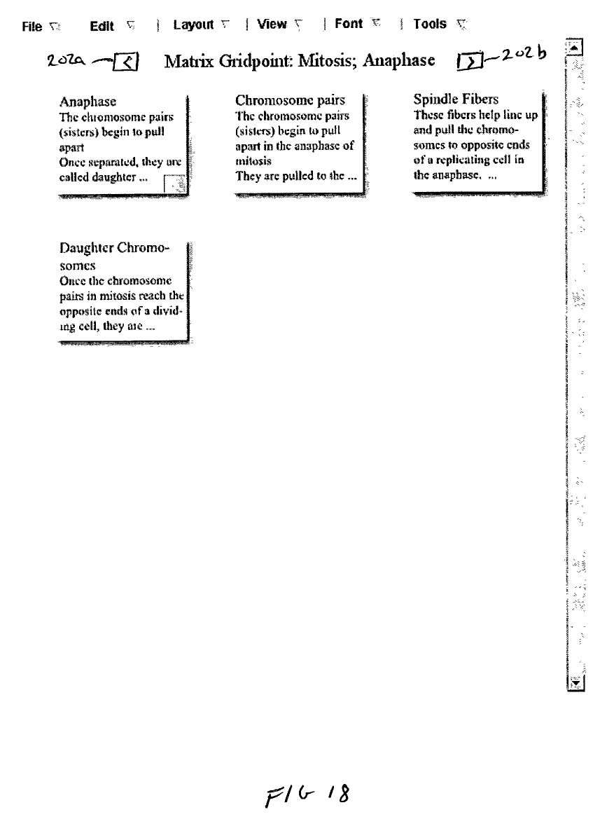

The note cards can also be shown in an Index Card view, an Outline View, and a Matrix View. When any of these views are selected, the note card screen is automatically switched to a full screen mode. In the index card view, the note cards of the note group are displayed in an array, for example, as seen in FIGS. 17 and 18. A “snap shot” of each note card is displayed with the title of the note card and a portion of the note text field displayed, and the note group name will be displayed above the array of note cards. If a note card is activated as a flash card, the flash card icon 66 will be visible on the note card. By clicking on any single note card, the selected note card will be displayed in full screen format. If the user clicks on a note stack, then the note stack will be expanded to an index card view, as seen in FIG. 18. The “Matrix” view is substantially similar to the Index Card view, but it is used in conjunction with the “matrix search” which is described below. As seen in FIG. 17, in the Matrix View, however, search terms are displayed along the top and side of the array of index cards. In the “Matrix” and “Index Card” view, note stacks are shown as multiple notes in a stack, with an indicator 68 on the top note card to indicate how many note cards are in the stack. By clicking on a note stack, the cards within the selected note stack will be displayed in an array (i.e., an index card view), as seen in FIG. 18. FIG. 18 is an expansion of one of the stacks from a Matrix search, which will be described below. Hence, it includes the search terms at the top of the screen. In an index card view (which is not a result of a matrix search), when a stack of note cards is expanded, the title of the note stack will be displayed at the top of the screen.

In the “Index Card” view, individual note cards can be combined together to form a stack. For example, a single note card can be selected and moved on top of another note card, or an existing stack of note cards. When the new card is added to a stack of note cards, the stack size indicator will be incremented to show that the new card has been added to the stack. If a new note stack is formed, it will be given a default title of, for example, “stack x”, where x is the n^{th} number of the stack formed. The note stack can be named, for example, by clicking on the note card stack title and typing in a new name for the stack. The user will then be able to edit the name of the note stack “in place”.

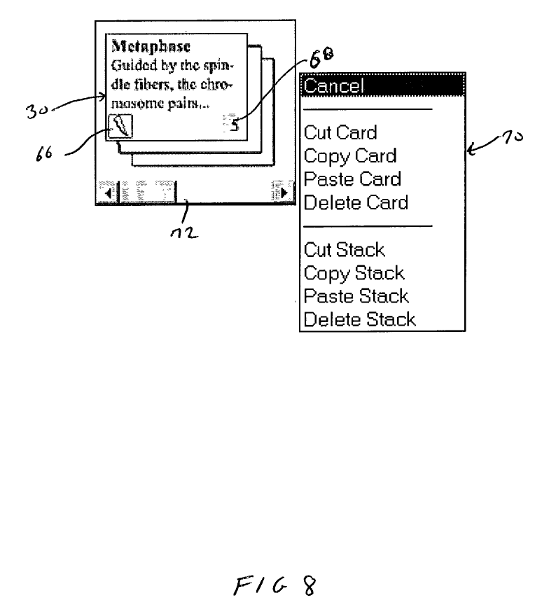

A note card can also be removed from the stack. For example, a representative stack of note cards is shown in FIG. 8. When the note card stack is selected a context sensitive pop-up menu 70 appears next to the note card stack and a scroll bar 72 appears below the scroll bar. With the scroll-bar 72, a user can scroll through the note cards 30 in the note card stack. The context sensitive pop-up menu gives the user the ability to cut, copy, paste and delete note cards, as well as to cut, copy, paste, and delete whole note card stacks. Thus, using the scroll bar 72, the user can scroll through the note card stack until a desired note card is found, and “cut” the desired note card from the stack, which, at that point will be at the top of the note card stack. This will “gray-out” the particular note card from the stack, but leave it in place until the user pastes the note card into another location in the note group. When a card is removed from (or added to) a stack of cards, the counter 68 which shows the number of note cards in the stack will automatically be decremented or incremented to show the number of note cards in the stack. Additionally, as noted, the pop-up menu 70 give the user the ability to cut, copy, past, and delete whole note card stacks. This might be desirable, for example, to move a sub-stack of note cards from within one note card stack to within another note card stack or to make a sub-stack of note cards a first level stack of note cards.

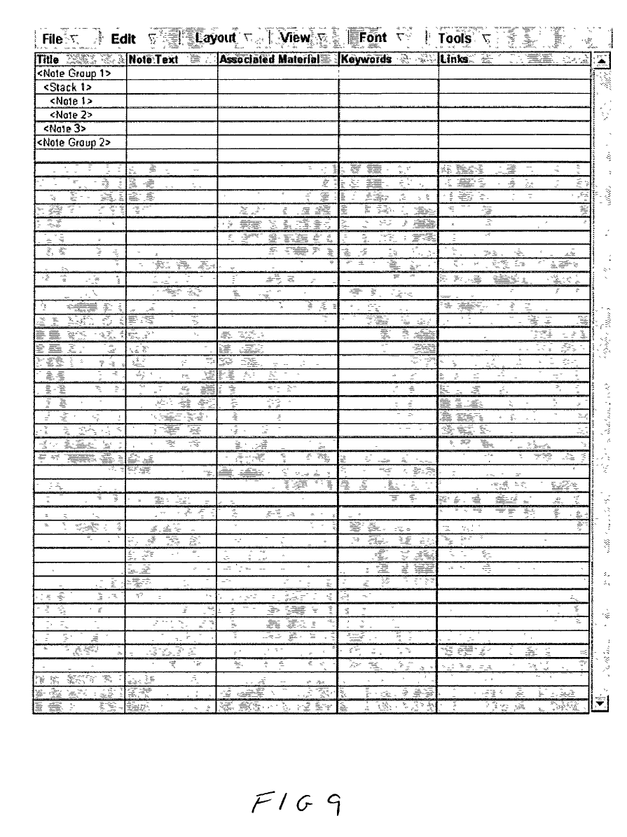

The “Outline” format is shown in FIG. 9, and is used to show basic information in table format. As seen, the first column includes the title of the note card groups, and note cards and note card stacks within the group. The titles are indented within the title column to show their relative level in the outline. Hence, note card groups are not indented. First level note card stacks and first level note cards are indented some. The note cards within note card stacks are then indented relative to the note card stack in which they are placed. Although no sub-stacks of note cards are shown, a sub-stack of note cards would be indented relative to the stack in which it was placed. Then the note cards within the sub-stack would be indented relative to the sub-stack itself. Other columns contain the note text field, the associated material filed, key word field, and links field. The columns are relatively short, and hence, only a small amount of information from each field will be shown in the column. In the outline format, the different levels or nodes (i.e., note card groups and note card stacks) can be provided with expand/collapse buttons, so that the individual elements in group of notes (i.e., note card stacks and individual note cards) and the note cards in a stack of note cards can be viewed or hidden as desired. As in the “Index” format, note card stacks can be formed by selecting a desired note and dragging it onto an existing note. This will create a new node in the “Outline” which will then contain two note cards. If a new note stack is formed, it will be given a default title of, for example, “stack x”, where x is the n^{th} number of the stack formed. The note stack can be named, for example, by expanding the note stack to an index view of the note stack and then clicking on the title of the note stack. The user will then be able to edit the name of the note stack “in place”. Note cards can be added to existing stacks of note cards by selecting a desired note card and dragging it onto an existing stack of cards. Further, a note can be removed from a stack of note cards by selecting a desired note and dragging it out of the note card stack, such that it is in the same level as the note stack. The note can also be dragged into another note sack, or dragged onto another note to form a new note stack. In addition, note card stacks can be moved in whole. Further, note cards and note card stacks can be deleted from the group. As can be appreciated, the outline view is essentially an organizational tool to help a user visualize the structure of the note group and allow for easy (and visual) organization of the note group. When in the note group, if a note stack is selected, the note stack will be viewed in Index view. Additionally, if a note card is selected, the note card will be brought up in a note card editor view (i.e., the view of FIG. 2).

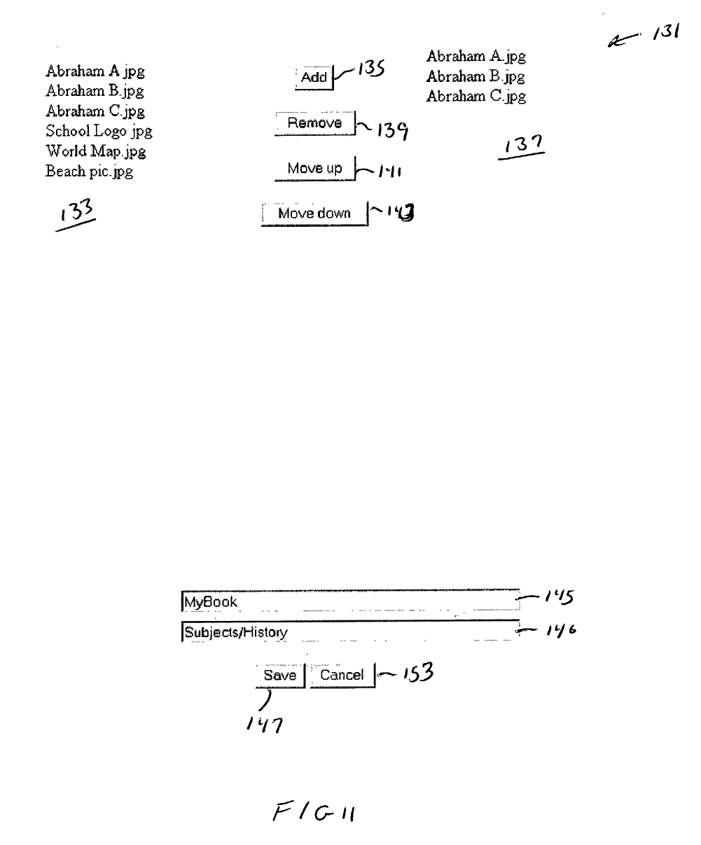

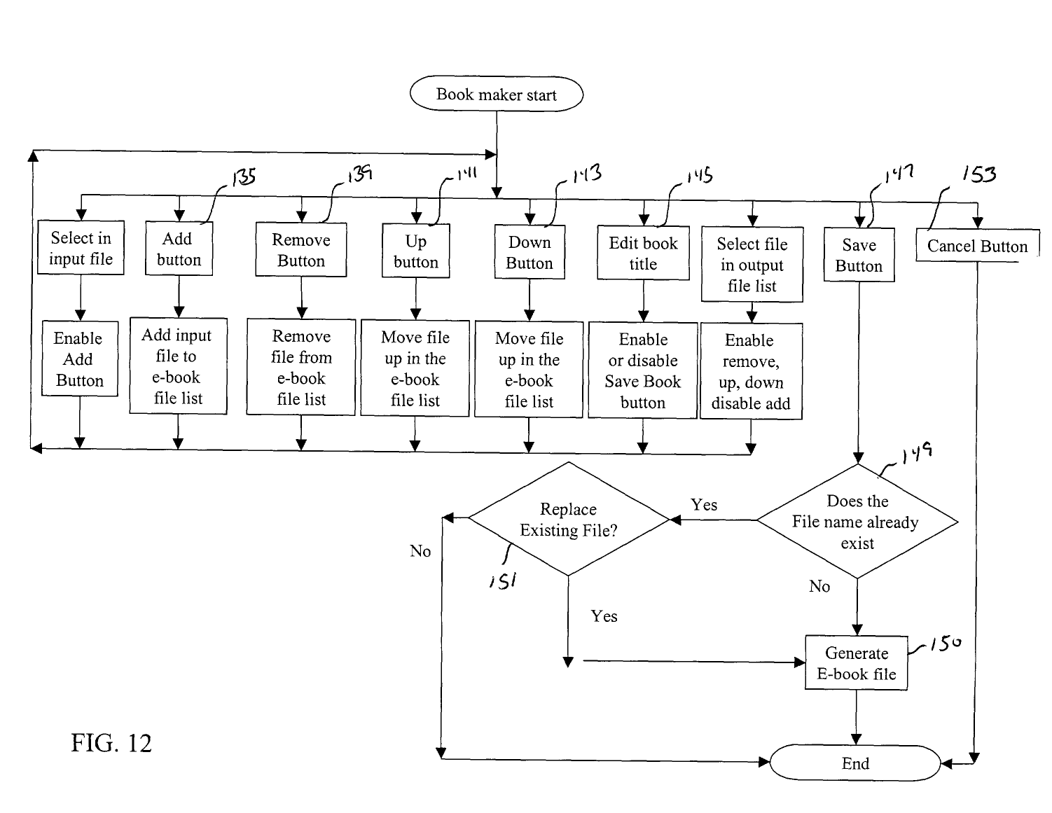

The functions of note taking, and book opening have been discussed above with respect to a specific content source which has been stored in the storage device of the unit 1, and then loaded into memory for reading. However, as shown in FIGS. 11 and 12, the user can combine files of different formats and/or different books to form the user's own user-defined “book.” To initiate this function, the user selects “Book Maker” under “Tools” from the menu bar (FIG. 4). When the user selects the “Book Maker” function, the user is presented with a dialog box 131. (FIG. 11) On one side of the dialog box is an input box 133 which lists the books, notes, and files stored on the storage device 5 of the unit 1. The user selects a file (i.e., a book or file) stored on the storage device 5 and activates the “add” button 135. The input file selected is then added to the file list in the box 137. The user continues to select input files, and add them to the file list until all desired files, book, etc. are added to the file list. If a file or book is inadvertently added to the file list, it can be removed using the “remove” button 139. When an input file is added to the file list, it is placed at the bottom of the list. By selecting an input file in the file list in the box 137, and using the “Move up” and “Move down” buttons 141 and 143, the input files can be placed in a desired order by the user. The order can be important. Once the user defined is saved, the selected files will appear in the order shown in the box 137.

Once all the input files have been added, the input files can be saved as a single file or “book”. The user enters a name for the user-made “book” in the book title block 145. In the “Save In” block 146, the user can select the “subject folder” in which the “book” is to be saved. Thus, if the user is making a history “book”, the “book” can be saved in a “history” folder. If the user is making a science “book”, the “book” can be saved in a “science” folder. When ready, the user activates the “save” button 147. The software first checks, as at 149 (FIG. 12), to make sure that the chosen name is not the name of an existing file. If the chosen name is a new name, the e-book file is saved, as at 150. If the chosen name corresponds to an existing name, the user will be prompted with another dialog box, as at 151, informing the user that the name exists, and giving the user the option to enter a new name, or overwrite the existing file. Once the user has opted to overwrite the existing file, or chooses a new name, the e-book is saved and opened. The user can then read, and take notes on, the new “book”, just as can be done with any other e-book or content source.

Should the user inadvertently select the “Book Maker” function, or otherwise desire to exit the “Book Maker” routine, the routine can be exited using the “cancel” button 153.

Note Organizing and Searching

To facilitate studying of the notes, the user can search selected note group(s) for specific words (categories) or attributes in the notes to produce a matrix 161 of the notes. Once the matrix has been generated, user will then be presented with a matrix 161, such as shown in FIG. 17. The matrix 161 has an X-axis 163 and a Y-axis 165. The search words for the X- and Y-axes appear at the top or side of the respective columns and rows. Notes 30 appear in each cell 167 of the matrix which satisfy the search requirements for the cell. That is, all notes including the word for X-category 1 and Y-Category 1 will be shown in cell 167_{1,1}. It will be appreciated that the complete note is not shown. To save space, the note title and a portion of the note text (or associated material) is shown in each cell. Additionally, the flashcard icon 67 will be visible (for example, as seen in the note card stack of FIG. 8)_if the note card shown on the top of the stack is activated as a flashcard. A stack size indicator 68 on the top note shows the number of notes in each cell. Thus, in cell 167_{1,1}, there are three notes; in cell 167_{2,1} there are three notes; and in cell 167_{1,2} there are two notes. An image of overlaying notes is provided in the cells that have multiple notes, to give a visual indication of which cells have multiple notes. As can be appreciated, each cell of the matrix which includes two or more note cards comprises a note stack.

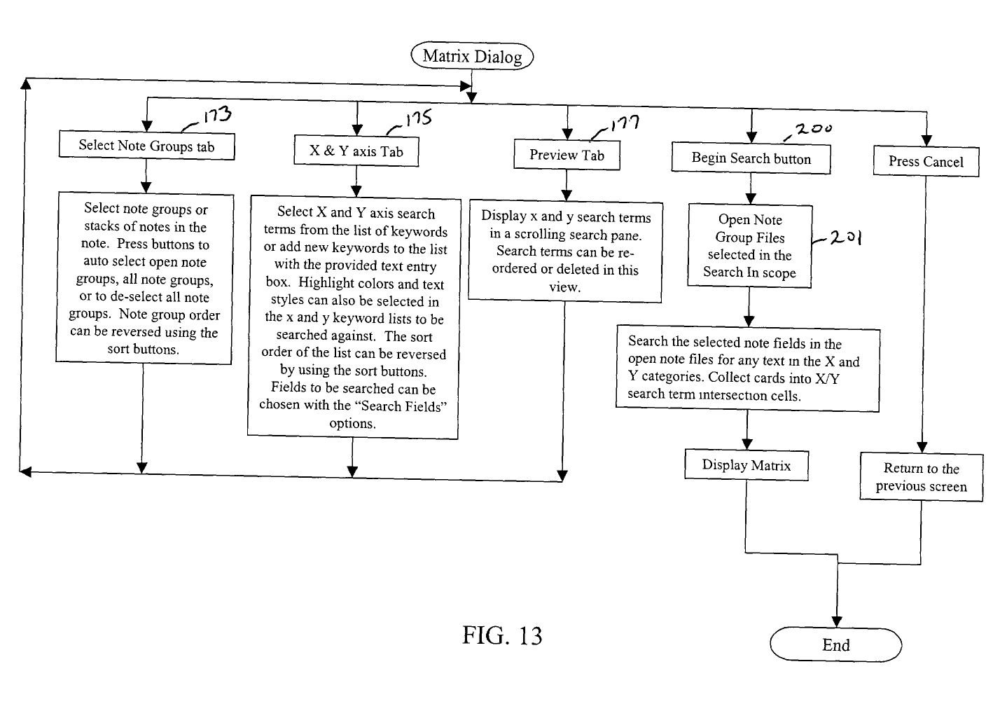

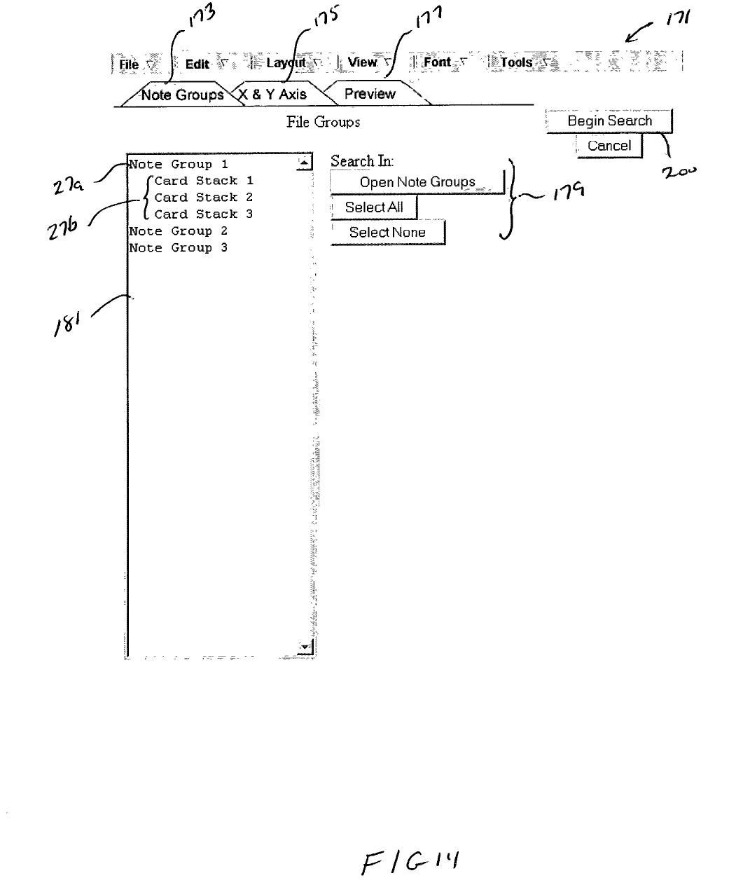

Referring to FIGS. 13-15, the user creates a matrix by selecting the “matrix” function from the tools menu (FIG. 4). The user is then presented with a matrix dialog box 171, such as shown in FIG. 14. The dialog box 171 includes three tabs: a note group selection tab 173, a search parameter selection tab 175, and preview tab 177. The contents of the “note group selection” tab 173 are shown in FIG. 14. On the right side of the tab, the user is provided with three “search in” options 179: search the open note group, select all note groups, and select none (or deselect all note groups). These options can be selected using buttons (as shown), check boxes, radio buttons, or other desired means. On the left side of the box, the user is provided with a selection box 181 in which the names 27a of note card groups and the names 27b of note card stacks are shown. As seen, the note card groups having note card stacks are expanded to show the note card stacks. Should a note card stack itself contain a note card sub-stack, that first level note card stack would be expanded to show the existence of the second level note card sub-stack. Hence, as can be appreciated, each note card stack of the note card group is shown in the selection box 181. If the user selects to search in “Open Note Groups” all note cards of the currently open note group will be searched. If the user selects “Select All”, all note cards of all the note card groups will be searched. As an alternative, the user can select desired notes card groups or note card stacks from the selection box 181. A user can opt to search select note card stacks within a note card group without selecting the entire note card group. If the user selects “Select None”, then the user will clear whatever selection has been made, and the user can make a new selection.

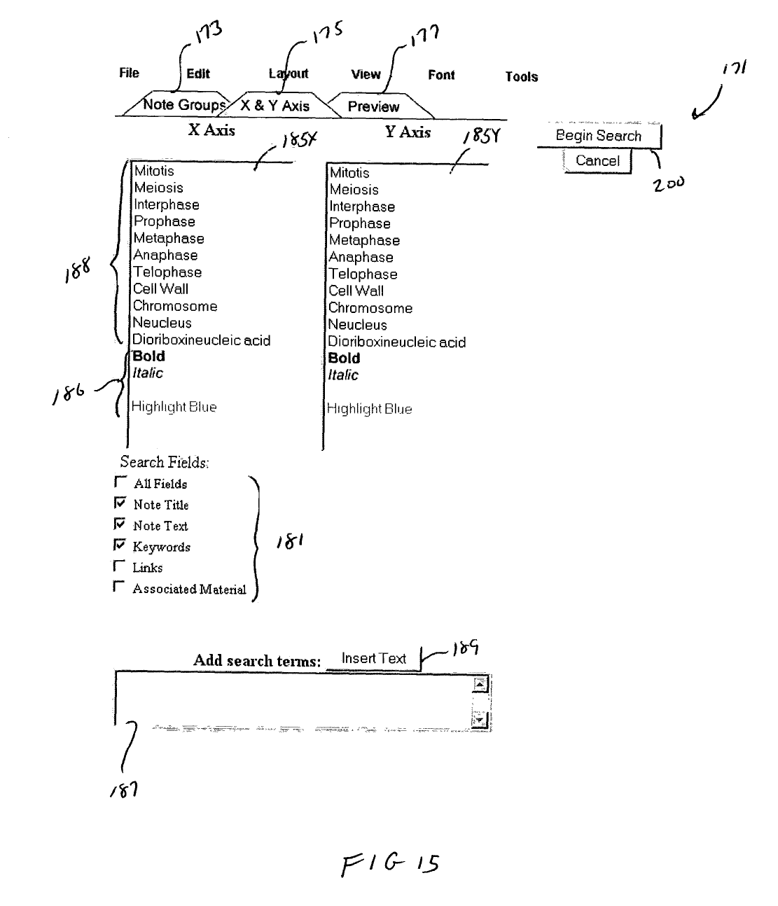

The search term selection tab 175 is shown in FIG. 15. The tab 175 includes two selection boxes 185X and 185Y. Each box is populated with the key words 188 which were entered into the keyword fields of the note cards in the group(s) or stack(s) of note cards selected to be searched. The two selection boxes 185X,Y are populated with the search terms only after the user has selected which note cards are to be searched in the note group selection tab 173. As can be appreciated, the two lists will be identical. The user can select the terms which will be searched by highlighting selected terms. If there are additional terms the user wants to search, but which are not in the list of key words in the selection boxes 185X,Y, additional search terms can be added by typing them in the “Add Search Terms” box 187 at the bottom of the tab 175, and then clicking the “insert text” button 189. This will insert the new search term in both boxes 185X and 185Y, and the user can opt to use the term as a search term for one or both of the X and Y search terms. Lastly, below the key words in each selection box 185X,Y, the user is given a selection of text attributes 186 which are used in the note cards that make up the set of note cards to be searched. These attributes include items such as italics, emboldened or underlined text, highlighting (by color), etc. The user can select these as search terms as well, again, by selecting them using the pointing device. As noted above, search terms need only be selected in one of the X and Y axes. If only X or Y axis search terms are selected, then the resulting matrix will be a single row or a single column. On the other hand, if search terms are selected in both the X and Y axis, the resulting matrix will be an x*y matrix, were x and y represent the number of search terms in the X and Y axes, respectively. Such a matrix is shown for example, in FIG. 17.

The user is also provided with several “Search Field” selectors 181, allowing the user to select which of the fields in the note cards are to be searched for selected terms or attributes. Thus, the user is given the choice of searching “all fields”, “Note Title”, “Note Text”, “Keywords”, “Links”, or “Associated Material”. As with the “search in” option buttons, the “search field”selector buttons can be in the form of check boxes, radio buttons, or other desired form.

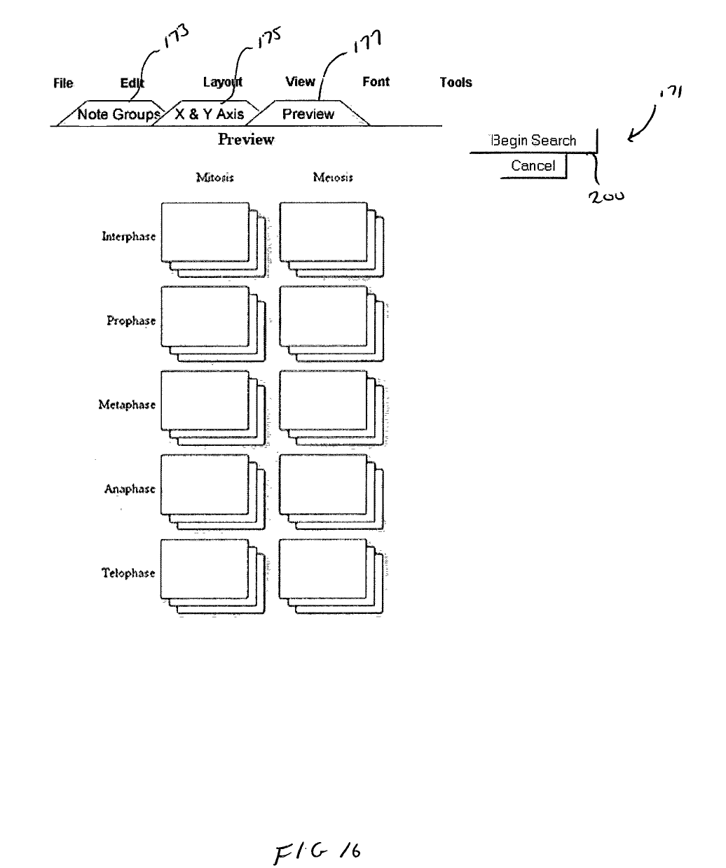

When the user has set all the parameters for the matrix search, the user click the preview tab 177. As seen in FIG. 16, the preview tab will show the terms and attributes that were selected to be search in a matrix format, with the terms and attributes selected in the X-axis box 185X across the top of the matrix and the terms and attributes selected in the Y-axis box 185Y down the side of the matrix. Representative note cards or note card stacks will be shown in the various cells of the matrix. However, inasmuch as the search has not yet been conducted, these representative note cards and note card stacks will be empty. By selecting search terms in the preview format, the user can rearrange the terms on the matrix, or eliminate terms from the search parameters. As can be appreciated, the preview tab shows only the search terms which will be used for the various cells of the matrix. The preview screen does not show the actual search results. It is provided to give the user an idea of what the matrix will look like (i.e., how large the matrix will be) after the search has been completed.

When ready, the user activates the “begin search” button 200. As can be appreciated, before the search can be conducted, the user must, at a minimum, select the notes to be searched in tab 173 and the search terms under tab 175. As seen in FIG. 13, when the “begin search” button is pressed, the software opens the selected note card group files, as at 201. It then searches the set of note cards selected for the note cards which contain intersections of the X and Y search terms. Hence, the program searches for all notes which have terms X₁and Y₁, X₁ and Y₂, X₁ and Y₃, X₂ and Y₁, etc. The notes that satisfy the intersection of search terms are than arranged in a matrix 161, as seen in FIG. 17 with the X and Y axis search terms for the columns and rows shown across the top of the array (or matrix) and down the side of the array (or matrix). Hence, in the matrix of FIG. 17, the three note cards in cell 167_{1,1} all contain the terms “mitosis” and “interphase”. As can be appreciated, each individual cell 167 which has more than one note card comprises a note card stack. By clicking on a cell, the individual note cards in the cell are displayed in index card form, as seen in FIG. 18. FIG. 18 shows the four cards in the cell 167_{1,4}. When a note group is shown in index card form, the note stack title is shown at the top of the screen. However, in the matrix module, the cell intersection search terms comprise the note stack title. Hence, these search terms appear at the top of the screen. Thus, for example, in FIG. 18, the note stack title is “Mitosis; Anaphase” which were the search terms for the particular cell of the matrix, and the notes within the note stack each contain these two terms.

The matrix 161 initially displayed after the program is done searching appears as a “three-dimensional” matrix, as shown in FIG. 17. As noted above, if several notes satisfy the search criteria (i.e., include both the X-category search term and the Y-category search term), the cell includes in the box 169, the number of notes in the particular cell. Hence, the depth of each cell 167 (which can vary from cell-to-cell) is the third dimension of the matrix array. However, all that is shown is the top note card in each cell 167. As noted above, the initial matrix display is in a matrix format or view (shown in FIG. 17), in which only the top note card (first note found) for each cell is displayed, and minimal information (i.e., the note title, a portion of the note text, and flashcard icon) regarding the note is displayed.

By activating a cell (for example, by double-clicking the cell), the note cards for the selected cell will be displayed edit view (as seen in FIG. 2) if the cell contains a single note card. On the other hand, if the cell contains a note card stack, activating the cell will cause the program to display the contents of the note card stack in an index card view, as seen in FIG. 18. In this instance, the screen contains the note cards 30 of the selected cell in an array. As with the matrix view, the note cards 30 for the cell are shown with minimal information (i.e., the note title, a portion of the note text, and the flashcard icon) sufficient to identify the note. At the top of the note screen, in the title bar, the search criteria for the cell is displayed. Along the side is a scroll bar to allow the user to scroll through cards of the note group or note stack. Next to the note title are two arrow buttons 202a,b that when activated buttons allow the user to move from one note card stack to the next note card stack in the parent index or matrix view without the need to return to the matrix view itself. For example, if the user is viewing a note card stack in cell (1,1), hitting the “next stack” button 202b will take the user to cell (1,2) (presuming this cell contains a note card stack), and the note card stack of this cell will be displayed in the index card view. If the user is at the bottom (or last cell) of a row, hitting the “next stack” button will take the user to the top (or first) note card stack of the next row. Using the “previous stack” button operates in just the opposite manner.

The user can save the matrix by selecting the “save” or “save as” function from the “file” menu in the menu bar 22 (FIG. 4). So that the program can differentiate between a matrix group of note cards and a “regular” group of note cards made using the note card editor, a “regular” note card group is saved with one extension, and a matrix note card group is saved with a different extension. Once a matrix has been saved as a matrix note card group, the matrix can be opened at a later date.

Viewing Notes

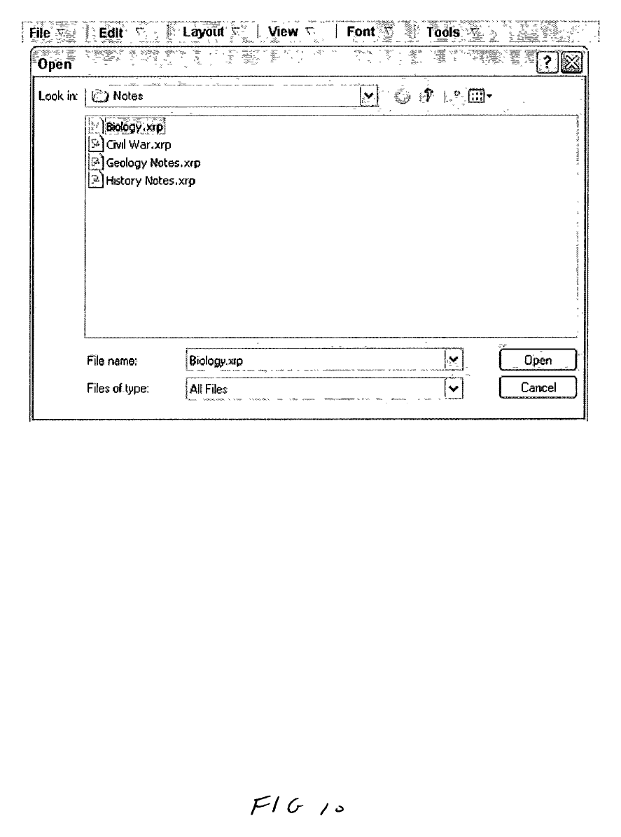

The user can choose to view note cards in several forms by selecting the desired option under the “layout” menu. As noted above, when in the matrix function, the matrix note card group can be viewed in matrix form, note card form, or single note form. When using the general note function (i.e., the user is not in the matrix mode), the view defaults to the single note card view or note card edit view. In this view, the user can use the “previous” and “next” note buttons 45 and 47 to move from note to note. However, to scan through the cards quickly, the user can choose the outline card view. This will show the notes substantially in form shown in FIG. 10, as described above, to show some or all of the note card fields in a table format.

The outline format allows for the user to see the structure of the note group as a whole, and allows for the user to organize the order of the notes and to organize the notes into note stacks, as described above.

Flashcards

Organizing the note cards in a matrix is one way of studying the notes. It allows the user to organize the note cards to find note cards with specific search terms, and which are presumably, related in a logical manner for the user. In another mode, the user can set up the note cards to be viewed as flashcards. Turning to FIG. 2, the user can activate the note card as a “flashcard” by pressing the flashcard icon button 65. To indicate to the user that the note card has been activated as a flashcard, the icon 66 within the icon button 65 will appear to indicate that the particular note card has been activated as a flashcard. If a note card is not activated as a flash card, the icon 66 will not be displayed. If desired, a flashcard that has previously been activated as a flashcard can be deactivated by again pressing on the icon button 65. In this case, the icon 66 will no longer be visible on the flashcard button 65. A deactivated flashcard can be reactivated by pressing on the icon button 65. If a flashcard is being activated for the first time, the flashcard preferences will be set to a flashcard default, as discussed below. If the default preferences of a flashcard are changed, the prior default preferences will stay with previously made flashcards, but he new default will affect all future flashcards, until the defaults are changed again. The view options for a specific session can be changed using the view menu, as noted above.

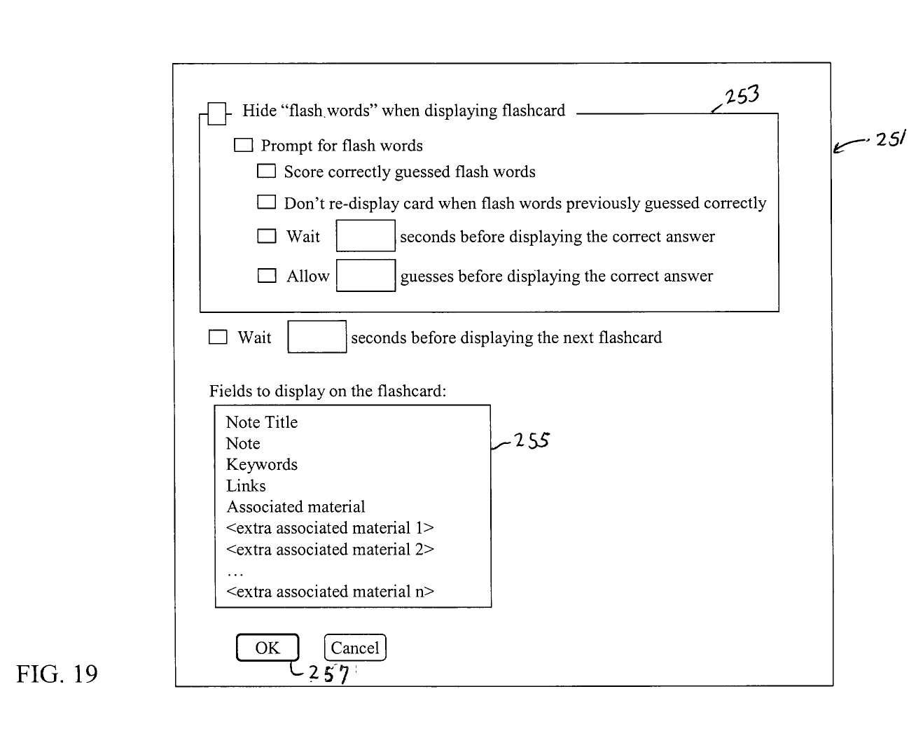

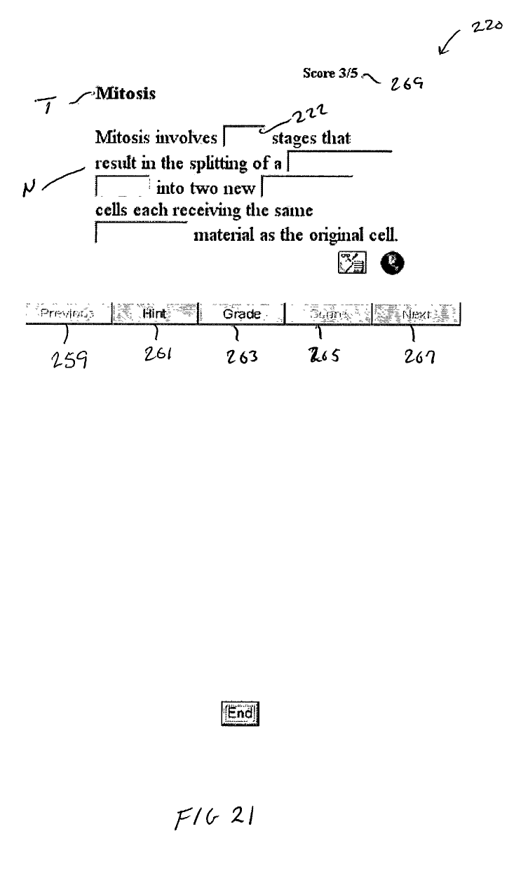

The flashcard preferences dialog box 251 is shown in FIG. 19. The preferences dialog box is activated by selecting “flash card preferences” under the “file” menu or selecting “global flash card setting” under the “view” menu of the menu bar 22. (FIG. 4). In an upper portion 253 of the dialog box, the user is given the option to hide the flashwords when displaying the flashcard. If the user opts to hide the flashwords, the flashcard, when displayed will appear as shown in FIG. 21. The user is also given the option to score correctly guessed flashwords, to disable the redisplay flashcards answered correctly, to automatically display the correct answers after a selected delay or after a selected number of wrong answers are entered, and to allow a specific number of tries to guess the correct answer to the flashcard. In a lower portion 255 of the dialog box, the user can choose which fields of the notes to display. The preferences are set by pressing the “OK” button 257 at the bottom of the dialog box 251.

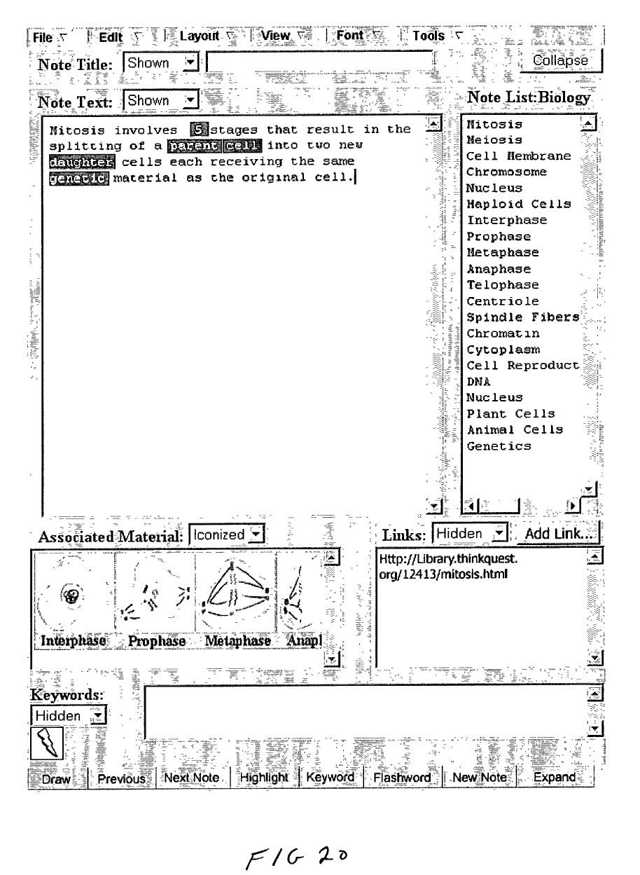

After a note card has been enabled as a flashcard, the user can select specific words or phrases in the note text or associated material fields which will be blanked out when the card is viewed as a flashcard. Although not preferred, words or phrases from any of the note card fields can be selected as flashwords, if desired. To select flashwords, the user presses the flashword button 53. The user is then presented with a “flashword” cursor. The user then selects words and/or phrases by clicking on desired words or phrases, or dragging the flashword cursor across selected words and/or phrases. This tags the specific words and/or phrases in the note as flashwords. Once the user is finished selecting flashwords for the note card, the user turns off flashword selection by again pressing the flashword button 53. In the normal view, the flashwords are shown highlighted in the note card, as seen in FIG. 20, so that the user can quickly see which words were selected as flashwords. If a user so desires, the flashword button 53 can be activated again to add flashwords to, or remove flashwords from, the note card.

Alternatively, a note card can be tagged as a flashcard without tagging any words as flashwords. This can be done, for example, by clicking on the flashcard icon box 66. This will allow for a review of selected (or tagged) note cards in the note card group. When a note card has been enabled as a flashcard, but without any flashwords being tagged, none of the words of the note card will be blanked out when the flashcard is viewed as a flashcard.

When a user tags note cards in a note card group as flashcards, the program saves the flashcard information in a flashcard file that is associated with the particular note card group. When the user alters the flashcards, by adding or removing flashcards, or adding or removing flashwords to previously activated flashcards, the flashcard file is updated accordingly.

The note cards which have been activated or tagged as flashcards can be reviewed by activating the “flashcard” option from the tools menu on the menu bar 22. When the flashcard function is activated, the user is presented an open file dialog box to select the flashcard file the user desires to review. If a note card group is currently opened, selecting of the flashword option can, by default, open the flashcard file associated with the currently open (and active) note card group, thereby bypassing the flashcard open dialog box.

When the notes are viewed in flashcard format with the “hide flashwords” activated, the note text is shown as a flashcard 220, as seen in FIG. 21. As seen, the flashcard 220 includes the title T of the note card and the text N of the note text field (or whatever field(s) have been selected to be displayed in the flashcard) with the flashwords replaced by an empty text box 222 (if “hide flashwords” has been selected). At the bottom of the flashcard 220, the user is provided with a series of buttons including a “previous” button 259, a “hint” button 261, a “grade” button 263, a “score” button 265, and a “next” button 267. At the top of the flashcard, the flashcard viewer displays at 269 users score, showing the number of correctly answered cards and the number of cards presented so far. The “next” and “previous” buttons enable the user to advance or switch between flashcards.

When the “hint” button 261, is pressed, the program will fill in the first empty (or incorrectly filled-in) text box 222 of the flashcard. To have the program fill in the remaining boxes 222, the user will have to press the hint button 261 for each additional box. The program will then fill in the boxes in order. The “hint” function can also be part of a context sensitive pop-up menu associated with the boxes of the flash card. Thus, this context sensitive pop-up menu can be activated for the blanks of a flash card in any desired order to fill in the blanks in any desired order.

When the “grade” button 263 is pressed, the program will compare the user's answers (i.e., the words and/or phrases entered into the boxes 222) against the correct answers (i.e., the hidden flashwords associated with each box 222), and indicate which boxes were filled in correctly and which were filled in incorrectly. For example, correctly filled in boxes could remain unchanged, or could be changed to a color, for example, green. Incorrectly filled in boxes could be filled in with the correct answer, and the correct answer could, for example, be in red print, to bring to the user's attention that the particular box was not properly filled in. In an alternative, pressing the “next” or “previous” buttons could automatically activate the grading function, so that all cards are “graded” prior to viewing another flashcard. The “score” button, when pressed will update the score indicator 269 at the top of the screen. Alternatively, the score indicator 269 can be automatically updated each time a card is graded. The score history can be stored with the flashcard file, or as a score file associated with the flashcard file. If scores are stored in a separate score file, then flashcard files can be provided to another user without the other user learning the user's scores.

In this answer or quiz mode, the flashcard viewer will cycle through the flashcards as the user presses the “next” and “previous” buttons. The viewer can present the flashcards in the order in which the note cards are arranged in the note group. Alternatively, the flashcards can be displayed in a random order. If the user does not answer (i.e., fill in) a flashcard correctly, the flashcard viewer will redisplay the flashcard later to give the user a further attempt to answer the card correctly. An incorrectly answered flashcard can be redisplayed until the user answers it correctly, or the user presses the “hint” button.

If the user opts not to hide the flashwords, the flashcard is shown as seen in FIG. 20, but with the boxes filled in. In this mode of operation, the program can be operated to simply advance the flashcards at a desired interval set in the dialog box 251, or the user can move through the flashcards using the “previous” and “next” buttons at the bottom of the flashcard.

As various changes could be made in the above constructions without departing from the scope of the invention, it is intended that all matter contained in the above description or shown in the accompanying drawings shall be interpreted as illustrative and not in a limiting sense. The note taking program can be written in any number of desired programming languages which are well known to programmers, or later become known to programmer. For example, and without limitation, the note taking program can be written as a database program (i.e., using Microsoft Access for example), or as an SQL program. The structure of the database in which the note card information is stored will be determined by the program or language in which the software is coded. Such data structures are well known to computer programmers. The flaschcard viewer can be written to be a module of the overall note taking program, or it can be written as a stand alone program which would simply access the note card file and allow viewing of note cards activated as flashcards. The appearance of the various screens and dialog boxes are illustrative only. The screens can be changed to appear in any desired manner. Additionally, the names of the various fields and buttons can be changed if desired. These examples are merely illustrative.

1. A method of generating electronic note cards on a computer, the computer including a display, an input device, and a storage device; the method comprising:
displaying a blank note card screen;
enabling a user to input text in a note text field; and
enabling a user to optionally input:
(a) a link to another file in a link field; said link comprising an address for a web page, a computer file, an electronic book, or a portion of an electronic book;
(b) at least one key word in a key word field; or
(c) associated material in an associated material field; said associated material including all or a portion of an electronic book, all or a portion of a computer file, or all or a portion of a web page, sound data, or picture data.

2. The method of claim 1 including a step of enabling the user to provide a title for said note card.

3. The method of claim 1 including a step of saving said note card in a note card group, said note card group containing one or more note cards.

4. The method of claim 3 including a step of forming note card stacks within each said note card group.

5. The method of claim 4 wherein said step of forming note card stacks comprises the step of associating together selected note cards within said note card group.

6. The method of claim 4 including a step of forming note card sub-stacks from notes cards contained within a selected note card stack of said note card group; said step of forming note card sub-stacks comprises the step of associating together selected notes cards within said selected note card stack.

7. The method of claim 3 including a step of storing said note card group on a machine readable media.

8. The method of claim 1 including a step of enabling a user to activate said note card to be viewed as a flashcard.

9. The method of claim 8 including a step of enabling a user to tag at least one user-selected word or phrase of said note card as a flashword.

10. A method of reviewing electronic notes in a flashcard format; the method comprising:
displaying a note card having text thereon;
enabling a user to tag at least one user-selected word of said text as flashword; and
displaying said text of said flashcard in a flashcard format with said flashword highlighted or with said flashword blanked out.

11. The method of claim 10 comprising automatically advancing through a series of flashcards at a predetermined time interval.

12. The method of claim 10 wherein the flashwords are displayed blanked out; the method further comprising displaying the blanked out flashword after a predetermined period of time.

13. The method of claim 10 wherein the flashwords are displayed blanked out; the method further comprising enabling a user to enter an answer in the blanked out section of the flashcard and comparing the user entered answer with the flashword.

14. The method of claim 13 including a step of displaying the flashword after a predetermined number of incorrect answers have been provided by a user.

15. The method of claim 13 including a step of scoring the correctly answered blanks in the flashcards.

16. A method of organizing data in a matrix format, the matrix comprising an X-axis, a Y-axis, and at least one cell; the data being contained in one or more electronic note cards stored in a computer readable media; the electronic note cards being contained in one or more note card groups; the method comprising:
receiving x X-axis search terms and y Y-axis search terms from a user; x and y being integers; the sum of x+y having a value of 1 or more;
searching the data for note cards which have both an X-axis search term and a Y-axis search term;
identifying which note cards contain both an X-axis search term and a Y-axis search term in the searched text;
forming a matrix of note cards into an array of x*y cells;
identifying which cell in said matrix to which each such identified note card belongs; and
displaying said matrix with note card identifying information in each cell.

17. The method of claim 16 including a step of indicating the number of note cards in a cell.

18. The method of claim 16 including a step of displaying all the notes in a single cell of said matrix in response to a user input request to view the note cards of said single cell.

19. The method of claim 16 including a step of displaying a note of a selected cell of said matrix in a full note view in response to a user input request to view the notes of said single cell.

20. The method of claim 16 wherein said X-axis and Y-axis search terms include words, phrases, and text characteristics.

21. A computer program product comprising a computer useable medium having computer program logic recorded thereon for enabling a processor in a computer system to organize data in note card format; said computer program logic comprising:
means for entering note information in each of a plurality of electronic note cards;
means for saving said plurality of note cards as a note card group; and
means for associating together selected note cards of said note card group as note stack.

22. The computer program product of claim 21 comprising means for associating together selected note cards of a selected note stack as a note sub-stack.

23. A computer program embodied in a computer readable media and being capable of being operated on a computer, the computer comprising a display, a storage device, an input device, and a memory device; the computer program being operable to generate electronic note cards and to organize the note cards; the computer program including:
means for generating one or more electronic note cards;
means for saving said note cards on said storage device; and
means for organizing the note cards in a matrix format;

24. The computer program of claim 23 wherein said means for organizing the note cards in a matrix format comprises:
means for receiving x X-axis search terms and y Y-axis search terms from a user; x and y being integers; the sum of x and y having a value of 1 or more;
means for searching the note cards for note cards which contain both an X-axis search term and a Y-axis search term;
means for identifying which note cards contain both an X-axis search term and a Y-axis search term in the searched text;
means for forming a matrix of note cards into an array of x*y cells;
means for identifying which cell in said matrix to which each such identified note belongs; and
means for displaying said matrix with note identifying information in each cell having a note which includes the X-axis search term and Y-axis search term of said cell.

25. The computer program of claim 23 including means for enabling a user to review the note cards in a flashcard format.

26. The computer program of claim 25 wherein said means for enabling a user to review the note cards in a flashcard format comprises:
means for displaying a note card;
means for tagging at least one user-selected word of said note card as a flashword;
means for tagging said note card as a flashcard; and
means for displaying said text of said flashcard in a flashcard format with said flashword highlighted or with said flashword blanked out.
